(19) United States
(12) Patent Application Publication
(10) Pub. No.: US 2010/0257681 A1
(43) Pub. Date: Oct. 14, 2010

(54) FLUID RECEIVING DEVICE WITH A WIPING LAYER AND A MANUFACTURING METHOD THEREOF

(76) Inventor: Chia-Ching LIN, Taipei City (TW)

Correspondence Address: Muncy, Geissler, Olds & Lowe, PLLC, 4000 Legato Road, Suite 310, FAIRFAX, VA, 22033, US

(21) Appl. No.: 12/423,353

(22) Filed: Apr. 14, 2009

(51) Int. Cl. B08B 1/00; B23P 11/00

(52) U.S. Cl. 15/104.94; 29/428

(57) ABSTRACT

A fluid receiving device with a wiping layer includes a container, a strip, a separating layer, a first wiping layer, and a second wiping layer. The container receives fluid. The strip is connected with the container. The separating layer is connected with one surface of the container. The container, the strip, and the separating layer are located between the first wiping layer and the second wiping layer. The separating layer, the first wiping layer, and the second wiping layer are combined. There is a receiving space between the second wiping layer and the separating layer. There is a through hole at one side of the second wiping layer and the separating layer. A manufacturing method for fluid receiving device with a wiping layer is also disclosed.

### BACKGROUND OF THE INVENTION

1. Field of the Invention

The present invention relates to a fluid receiving device with a wiping layer that can receive fluid and easily release the fluid for wiping, and a manufacturing method thereof.

2. Description of Related Art

When people sweat or are stained while outdoors, people often wipe their face, sweat on their limbs, or general uncleanness by wet paper towel. However, the wet paper towel is hard to preserve and maintain, since the wet paper tower with moisture becomes dry and loses the function of its wetness after a long time passes or after being opened due to the influence of external temperature. Furthermore, when people wipe windows, display windows, or other objects, people uses a wiper to dip in water and wrench the wiper thy or sprays the cleaning agent on the wiper so as to wipe the windows, display windows or other objects. However, this way of usage, a water tank or cleaning agent has to be prepared in advance, otherwise people needs to make a detour to the water source, and can not directly begin wiping by simply having the wiper. It is inconvenient. Especially, is the requirement for a separate source of water or cleaning agent is a problem for people that has no ready access to water or cleaning agent but wishes to wipe objects.

### SUMMARY OF THE INVENTION

One particular aspect of the present invention is to provide a fluid receiving device with a wiping layer and a manufacturing method thereof. The fluid receiving device can easily release fluid and the fluid permeates into the wiping layer for wiping.

The fluid receiving device with a wiping layer includes a container for receiving fluid, a strip is connected with the container, and a separating layer is connected with one surface of the container, a first wiping layer, and a second wiping layer. The container, the strip, and the separating layer are located between the first wiping layer and the second wiping layer. The separating layer, the first wiping layer, and the second wiping layer are combined. There is a receiving space between the second wiping layer and the separating layer. There is a through hole at one side of the second wiping layer and the separating layer.

The present invention also provides a manufacturing method for the fluid receiving device with a wiping layer, and includes the following steps. A container with fluid is manufactured. A strip is connected with the container. A separating layer is connected with the container. The container, the strip, furthermore the separating layer are located between a first wiping layer and a second wiping layer so that there is a receiving space between the second wiping layer and the separating layer, and there is a through hole at one side of the second wiping layer and the separating layer.

The present invention has the following characteristics. The fluid receiving device with a wiping layer of the present invention cooperates with the first wiping layer that is adjacent to the container, thereby can easily release fluid, and the fluid thereby permeates into the first wiping layer for wiping.

The present invention further has a second wiping layer for performing the dry wipe so as to enhance the wiping function.

The present invention has a separating layer that can prevent the fluid from permeating into the second wiping layer and the receiving space, so that the user's hand and the second wiping layer can be kept dry. The separating layer has a good separating and protection effect.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

FIG. 1 is an exploded perspective view of the fluid receiving device with a wiping layer according to the present invention;

FIG. 2 is an assembly perspective view of the fluid receiving device with a wiping layer according to the present invention;

FIG. 3 is a cross-sectional diagram of the fluid receiving device with a wiping layer according to the present invention;

FIG. 4A˜4E are schematic diagrams of the manufacturing process of the container according to the present invention;

FIG. 5 is a flow chart of the manufacturing method for the fluid receiving device with a wiping layer according to the present invention;

FIG. 6 is an operation schematic diagram of the fluid receiving device with a wiping layer according to the present invention; and

FIG. 7 is another operation schematic diagram of the fluid receiving device with a wiping layer of the present invention.

### DETAILED DESCRIPTION OF THE PREFERRED EMBODIMENTS

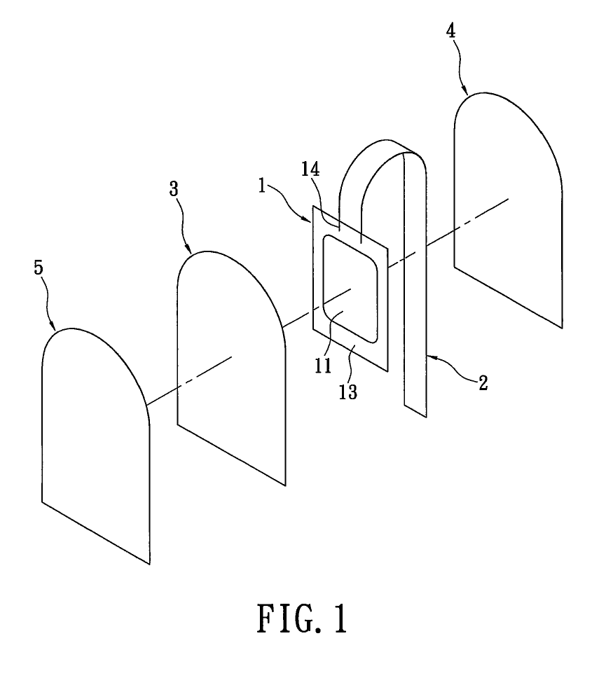

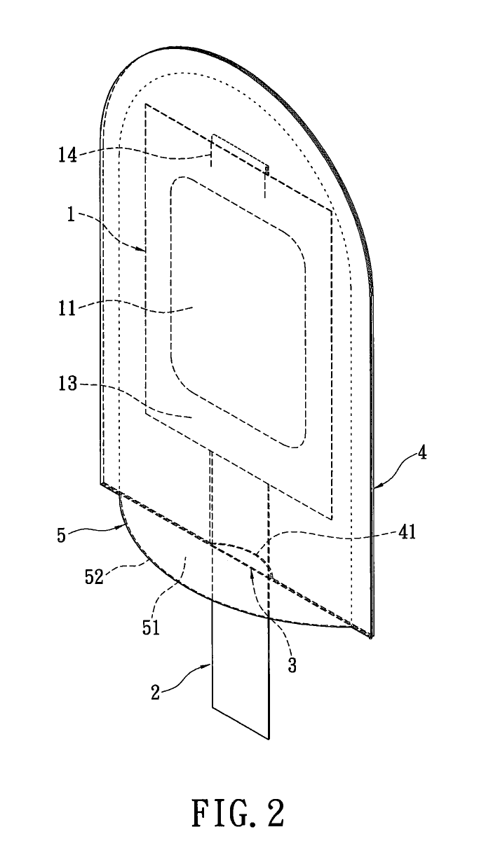

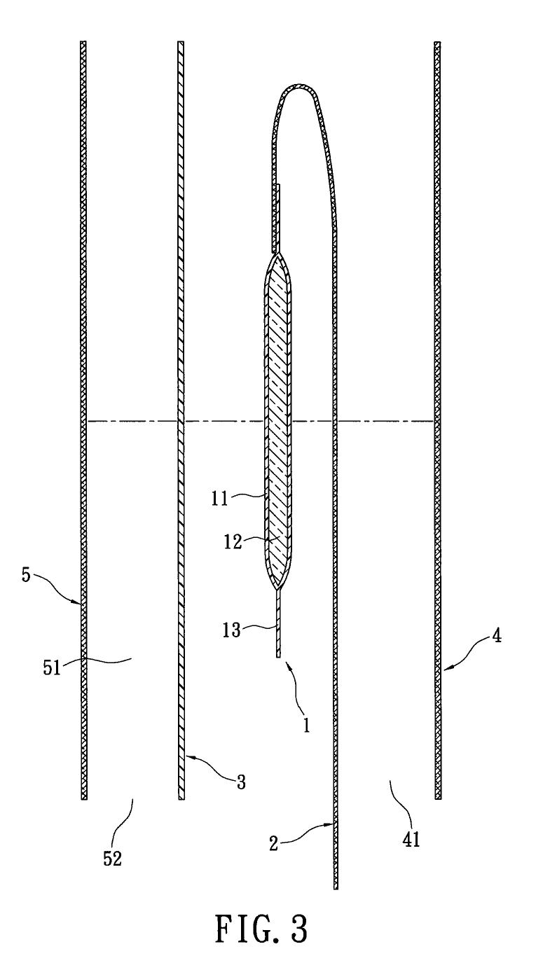

Reference is made to FIGS. 1˜4E. The fluid receiving device with a wiping layer includes a sealed container 1, a strip 2, a separating layer 3, a first wiping layer 4, and a second wiping layer 5. The container 1 can receive fluid 12, such as cleaning fluid, water, lotion, maintenance fluid, or medical fluid, etc. The type of the fluid 12 is not limited to a specific one, and can be liquid fluid, lacteal fluid, gel-like fluid, or other type of fluid. The four edges of the container 1 are sealed so that the received fluid 12 is sealed within the container 1.

The shape of the strip 2 is rectangular, but not limited thereby. The strip 2 is connected with the container 1. One end of the strip 2 is connected with the sealed edge 13 located at the upper side of the container 1. Each of the two sides of the sealed edge 13 of the container that are adjacent to the strip 2 has a notch 14. Another end of the strip 2 bends downwards so that another end of the strip 2 extends out of the lower side of the container 1 with a proper length. In addition to being connected with the container 1 via an assembling way, the strip 2 also can be integrated with the container 1 as one piece.

The separating layer 3 is made of water proof material. The dimension of the separating layer 3 is larger than the dimension of the container 1. The container 1 is connected with the separating layer 3 so that the separating layer 3 is connected with one surface of the container 1.

The first wiping layer 4 and the second wiping layer 5 are made of material that can be permeated by fluid. The outline of the first wiping layer 4 and the second wiping layer 5 corresponds to the outline of the separating layer 3. The container 1, the strip 2, and the separating layer 3 are located between the first wiping layer 4 and the second wiping layer 5 so that the container is located between the separating layer 3 and the first wiping layer 4. The edges of the first wiping layer 4, the second wiping layer 5, and the separating layer 3 are combined together so that the separating layer 3, the first wiping layer 4, and the second wiping layer 5 are combined into one piece.

There is a perforation 41 between the first wiping layer 4 and the separating layer 3, and the perforation 41 is located at the lower side so that another end of the strip 2 extends out of the lower side of the container 1 and the first wiping layer 4 with a proper length via the perforation 41, thereby the user can pull the strip 2.

There is a receiving space 51 between the second wiping layer 5 and the separating layer 3. There is a through hole 52 between the second wiping layer 5 and the separating layer 3, and the through hole 52 is located at the lower side. A portion of the user's hand can extend into the receiving space 51 via the through hole 52 for using the fluid receiving device with a wiping layer.

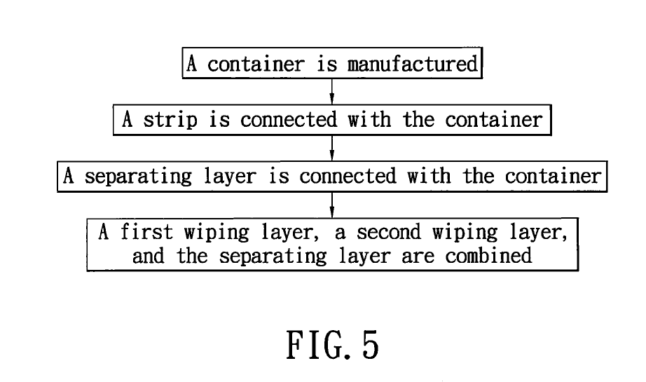

Reference is made to FIG. 5. The present invention also provides a manufacturing method for the fluid receiving device with a wiping layer, and includes the following steps.

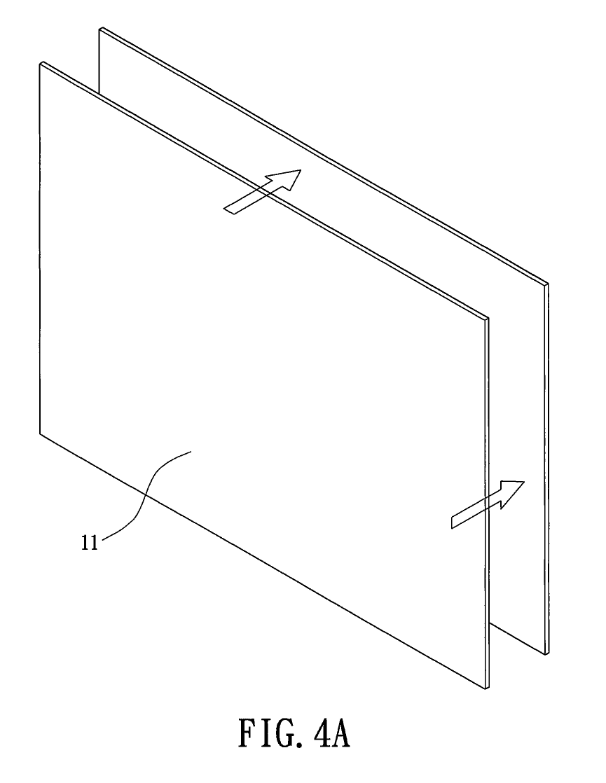

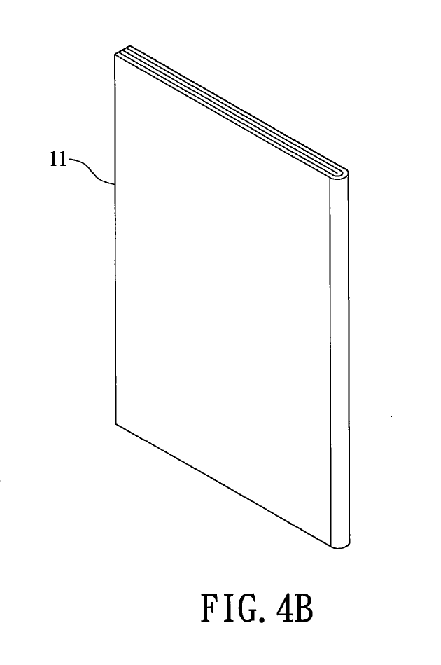

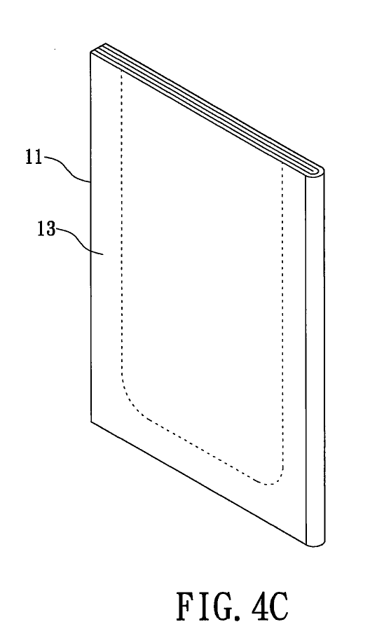

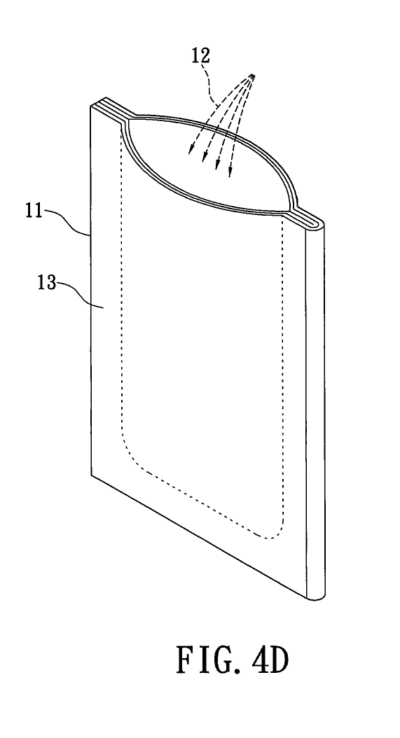

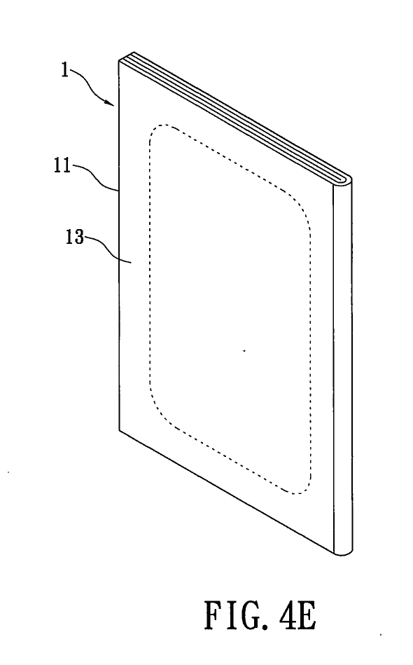

1. Manufacturing a container 1. The container 1 is made of PVC, PET, nylon, or aluminum foil, but not limited thereby. The material of the container 1 can be changed to match the fluid 12. In this embodiment, the container 1 is manufactured by the following steps. Two square sheet structures 11 are stacked (as shown in FIG. 4A, the quantity of the sheet structures may also be one, three, or four, etc), and the two square sheet structures 11 are turned back halfway (shown in FIG. 4B). The three edges of the turned back sheet structures 11 are melted by supersonic wave or sealed by other ways (as shown in FIG. 4C). The fluid 12 is added into the sealed sheet structures 11 (as shown in FIG. 4D), and the fourth edge is sealed (as shown in FIG. 4E) so as to form the container 1 with four sealed edges 13. The container 12 thereby received the fluid 12. The fluid 12 can be cleaning fluid, water, lotion, maintenance fluid, or medical fluid, etc. The manufacturing method of the container 1 is not limited thereby, and can be other ways.

2. Connecting a strip 2 to the container 1. One end of the strip 2 is connected with the sealed edge 13 located at the upper side of the container 1 by ultrasonic wave or other ways. Each of the two sides of the sealed edge 13 of the container 1 that are adjacent to the strip 2 has a notch 14. Another end of the strip 2 bends downwards. Another end of the strip 2 extends out of the lower side of the container 1 with a proper distance so that the user can pull the strip 2. When the strip 2 is pulled, the container 1 can be easily torn open by utilizing the notch 14.

3. Connecting a separating layer 3 to the container 1. The separating layer 3 is made of waterproof material. In this embodiment, the separating layer 3 is made of waterproof nonwoven fabric. The container 1 also is connected with the separating layer 3 by ultrasonic wave or other ways so that that the separating layer 3 is connected with one surface of the container 1.

4. Connecting the first wiping layer 4 and the second wiping layer 5 with the separating layer 3. The first wiping layer 4 and the second wiping layer 5 are made of material that can be permeated by fluid and wiped. The thickness of the first wiping layer 4 and the second wiping layer 5 can be determined by the requirements. In this embodiment, the first wiping layer 4 and the second wiping layer 5 are made of nonwoven fabric or other materials. The container 1, the strip 2, and separating layer 3 are located between the first wiping layer 4 and the second wiping layer 5. The edges of the first wiping layer 4, the second wiping layer 5, and the separating layer 3 are combined by ultrasonic wave, sewing, or other ways so that the separating layer 3, the first wiping layer 4, and the second wiping layer 5 are combined.

While combining the edges of the first wiping layer 4, the second wiping layer 5, and the separating layer 3, the lower side of the first wiping layer 4 and the separating layer 3 that corresponds to the strip 2 is not combined, so that there is a perforation 41 located at the lower side of the first wiping layer 4 and the separating layer 3. Thereby, another end of the strip 2 extends outside of the lower side of the container 1 and the first wiping layer 4 via the perforation 41 with a proper distance.

Furthermore, there is a receiving space 51 between the second wiping layer 5 and the separating layer 3, and the lower side of the second wiping layer 5 and the separating layer 3 are not combined. Thereby, there is a through hole 52 between the lower sides of the second wiping layer 5 and the separating layer 3 for letting a portion of user's hand enter.

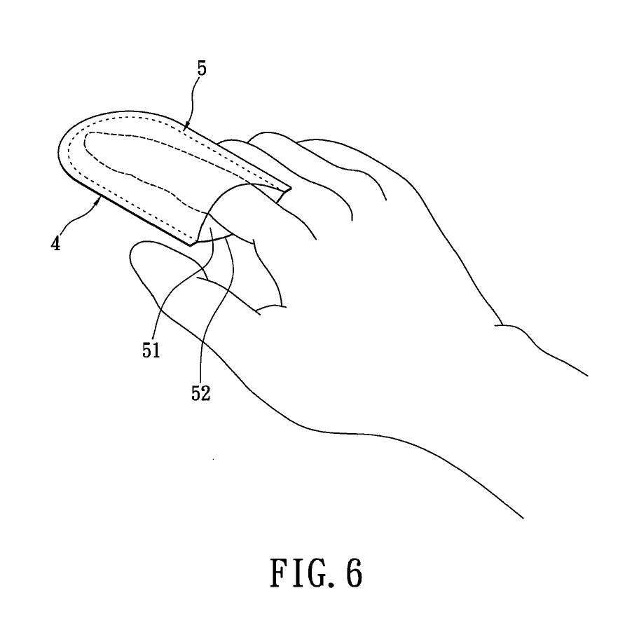

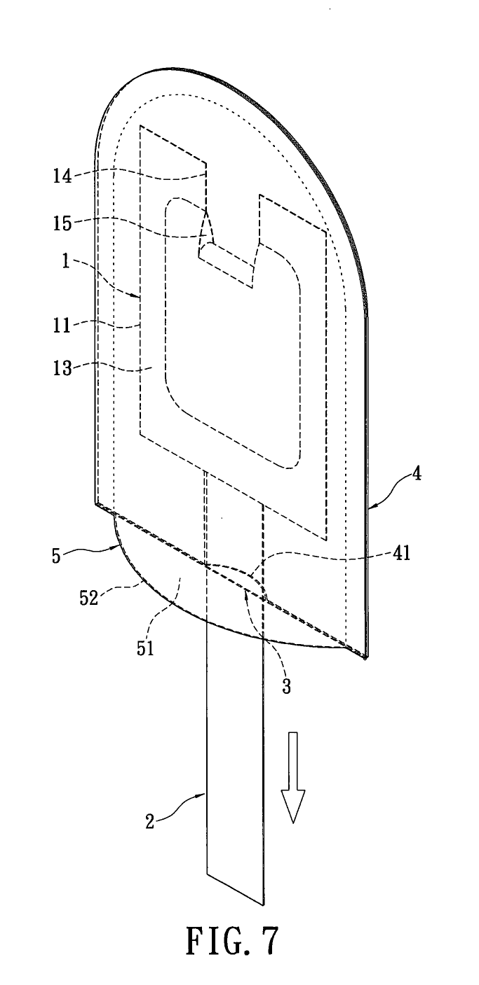

Reference is made to FIG. 6. When the present invention is used, a portion of the user's hand extends into the receiving space 51 located between the second wiping layer 5 and the separating layer 3, and pulls the strip 2 so that an opening 15 (as shown in FIG. 7) is formed due to the container 1 is torn by the strip 2. Moreover, the strip 2 is taken off so that the fluid 12 in the container 1 flows out via the opening 15 and permeates the first wiping layer 4. Therefore, the first wiping layer 4 can wipe the user' face, limbs, or window, display window, or other objects. The problem pf carrying wet paper is solved. Furthermore, the second wiping layer 5 that is not attached with the fluid 12 can perform the dry wiping.

The present invention has the following characteristics.

1. The container 1 that can receive the fluid 12 cooperates with the first wiping layer 4 of the container 1 may easily release fluid 12, and the fluid 12 permeates into the first wiping layer 4 for wiping.

2. The present invention further has the second wiping layer 5 for performing dry wipe thereby enhance the wiping function.

3. The present invention has a separating layer 3 that can prevent the fluid 12 from permeating into the second wiping layer 5 and the receiving space 51, so that the user's hand and the second wiping layer 5 can be kept dry. This is especially important for the fluid 12 that is not suitable for contact by the human body; the separating layer 3 has a good separating and protection effect.

The description above only illustrates specific embodiments and examples of the present invention. The present invention should therefore cover various modifications and variations made to the herein-described structure and operations of the present invention, provided they fall within the scope of the present invention as defined in the following appended claims.

What is claimed is:

1. A fluid receiving device with a wiping layer, comprising:
a container receiving with a fluid;
a strip connected with the container;
a separating layer connected with one surface of the container;
a first wiping layer; and
a second wiping layer, wherein the container, the strip, and the separating layer are located between the first wiping layer and the second wiping layer, furthermore the separating layer, the first wiping layer, and the second wiping layer are combined, such that there is a receiving space between the second wiping layer and the separating layer, and there is an through hole at one side of the second wiping layer and the separating layer.

2. The fluid receiving device with a wiping layer as claimed in claim 1, wherein the container has sealed edges, the fluid is sealed in the container, and one end of the strip is connected with the sealed edge at one side of the container.

3. The fluid receiving device with a wiping layer as claimed in claim 2, wherein each of the sealed edged of the container that are adjacent to the strip has a notch.

4. The fluid receiving device with a wiping layer as claimed in claim 1, wherein another end of the strip bends downwards, and extends outside of one side of the container and the first wiping layer.

5. The fluid receiving device with a wiping layer as claimed in claim 4, wherein there is a perforation between the first wiping layer and the separating layer, and another end of the strip extends outside of one side of the container and the first wiping layer via the perforation.

6. The fluid receiving device with a wiping layer as claimed in claim 1, wherein the separating layer is made of waterproof material, and the first wiping layer and the second wiping layer are made of material that is permeable for fluid.

7. A fluid receiving device with a wiping layer, comprising:
a container receiving with a fluid;
a strip connected with the container;
a separating layer connected with one surface of the container; and
a first wiping layer, wherein the container is located between the separating layer and the first wiping layer, and the separating layer and the first wiping layer are combined.

8. A manufacturing method for the fluid receiving device with a wiping layer, comprising:
manufacturing a container with a fluid;
connecting a strip with the container;
connecting a separating layer with one surface of the container; and
wherein the container, the strip, and the separating layer are located between a first wiping layer and a second wiping layer, furthermore the first wiping layer, the second wiping layer, and the separating layer are combined so that there is a receiving space between the second wiping layer and the separating layer, and so that there is a through hole at the second wiping layer and the separating layer.

9. The manufacturing method for the fluid receiving device with a wiping layer as claimed in claim 8, wherein the container is made of PVC, PET, nylon, or aluminum foil.

10. The manufacturing method for the fluid receiving device with a wiping layer as claimed in claim 8, wherein the fluid is cleaning fluid, water, lotion, maintenance fluid, or medical fluid.

11. The manufacturing method for the fluid receiving device with a wiping layer as claimed in claim 8, wherein the container is made by at least one sheet structured material that is turned back halfway and three edges of the turned sheet structured material are sealed, the fluid is added into the sealed sheet structured material, and the fourth edge is sealed to form the container with four sealed edged.

12. The manufacturing method for the fluid receiving device with a wiping layer as claimed in claim 11, wherein one end of the strip is connected with the sealed edge at one side of the container by ultrasonic wave, each of the sealed edged of the container that are adjacent to the strip has a notch, and another end of the strip bends downwards, and extends outside of one side of the container and the first wiping layer.

13. The manufacturing method for the fluid receiving device with a wiping layer as claimed in claim 8, wherein the container is connected with the separating layer by ultrasonic wave melting way.

14. The manufacturing method for the fluid receiving device with a wiping layer as claimed in claim 8, wherein the separating layer is made of waterproof material, and the first wiping layer and the second wiping layer are made of material that is permeable for fluid.

15. The manufacturing method for the fluid receiving device with a wiping layer as claimed in claim 8, wherein the separating layer is made of waterproof nonwoven fabric.

16. The manufacturing method for the fluid receiving device with a wiping layer as claimed in claim 8, wherein the first wiping layer and the second wiping layer are made of nonwoven fabric.

17. The manufacturing method for the fluid receiving device with a wiping layer as claimed in claim 8, wherein the first wiping layer, the second wiping layer, and the separating layer is combined by an ultrasonic wave melting way or a sewing way.

18. The manufacturing method for the fluid receiving device with a wiping layer as claimed in claim 8, wherein one side of the first wiping layer and the separating layer that corresponds to the strip is not combined so that there is a perforation between the first wiping layer and the separating layer, and the strip extends to outside of the container and the first wiping layer through the perforation.
